(19) United States
(12) Patent Application Publication
(10) Pub. No.: US 2014/0136494 A1
(43) Pub. Date: May 15, 2014

(54) SYSTEM AND METHOD FOR AUTOMATIC WRAPPER INDUCTION BY APPLYING FILTERS

(71) Applicant: Homer TLC, Inc., Wilmington, DE (US)

(72) Inventor: Siva Kalyana Pavan Kumar Mallapragada Naga Surya, Atlanta, GA (US)

(73) Assignee: Homer TLC, Inc., Wilmington, DE (US)

(21) Appl. No.: 13/837,644

(22) Filed: Mar. 15, 2013

Related U.S. Application Data
(60) Provisional application No. 61/726,155, filed on Nov. 14, 2012.

(51) Int. Cl. G06F 17/30

(52) U.S. Cl. CPC G06F 17/30289
USPC 707/694

(57) ABSTRACT

Information from a plurality of domains is automatically extracted according to an iterative application of rules. A first rule is generated based on a target string. The first rule comprises at least one filter. A domain of interest is identified and a training set is generated using the target string and at least one document in the domain of interest. The first rule is applied to each document in the training set to obtain a first of target results. The first set of target results are compared to desired set of target results. Based on the comparison, a second rule may is created and applied to the training set to yield an improved second set of target results.

### CROSS-REFERENCE TO RELATED APPLICATIONS

This application claims priority to U.S. Provisional Application Ser. No. 61/726,155, filed Nov. 14, 2012 and entitled “SYSTEM AND METHOD FOR AUTOMATIC WRAPPER INDUCTION,” which is hereby incorporated by reference in its entirety. This application is also related to co-pending, commonly assigned U.S. patent application Ser. No. ______ [having attorney docket no. HOMR.P0477US], filed Mar. 15, 2013, and entitled “SYSTEM AND METHOD FOR AUTOMATIC WRAPPER INDUCTION USING TARGET STRINGS,” the disclosure of which is incorporated herein by reference in its entirety. A copy of U.S. patent application Ser. No. ______ [having attorney docket no. HOMR.P0477US] is attached hereto as Appendix E.

### TECHNICAL FIELD

The present disclosure relates generally to information extraction and, particularly, to extraction of information from unstructured and partially structured documents across unbounded or substantially unbounded domains.

### BACKGROUND

It is often desirable to extract data that are consistent across a broad number of web pages hosted by various domains on the World Wide Web. These may include, for example, price, Universal Product Codes (UPC), Manufacturer Part Numbers (MPN), or product specification data from product pages; or phone numbers and email addresses from personal web pages.

This process can be relatively simple when the domains provide a standardized or universal query application programming interface (API) to access the information. However, the nature of the World Wide Web is that each domain structures its web pages in its own way and there is no consistent way to extract desired information from those pages. A program that automatically extracts information from these unstructured web pages is called a “wrapper,” and typically needs to be specially configured for each domain. Given the large number of web domains, however, it is not feasible to write a separate program to extract information for each domain.

A naïve method for doing so would be to manually examine the Hypertext Markup Language (“HTML”) code for a given web domain and determine what the tags for the data of interest are, and program a search algorithm to search the pages of the domain and its associated sub-domains for the tag and return the corresponding data. However, given the sheer number of web domains that may be of interest, the time expenditure may be prohibitive.

Previous attempts at generalizing information extraction across multiple domains include STALKER and WEIN. Further discussions on STALKER and WEIN and related concepts can be found in Appendices A-D accompanying and forming part of this disclosure, and which are hereby incorporated by reference in their entirety. The key assumptions underlying these approaches can be excessively restrictive to current web pages using latest web technologies.

These solutions represent the HTML as a tree, where each tag is a node. They navigate the HTML tree down to the node where the search term is found, and record the path taken through the tree to reach the node. The recorded path is then used to navigate the previously unseen pages to extract information in that node.

Thus, the prior art methods are limited and/or are dependent upon the page being pure HTML. Further, the prior art methods are unable to handle raw HTML which may include JavaScript code, JavaScript Object Notation (“JSON,”) and other non-HTML content web pages or documents.

### SUMMARY

Embodiments disclosed herein can extract information from any partially structured pages, HTML or beyond. For purposes of this disclosure, “partially structured” simply means there is some “structure” in the page, i.e., it is not an arbitrary collection of words. The partial structure facilitates identifying markers that help locate the target string and occur consistently across the pages. Embodiments extract information by implementing a training phase to identify one or more rules and an application phase to apply the one or more rules to millions of web pages. In some embodiments, data (such as a price) is picked for an actual product, rules are identified, and an iterative filtering is used, wherein in every iteration, portions of the page are removed until the desired data is obtained.

That is, embodiments can iteratively remove chunks of text that do not contain the target information from the given page, until the target information is left. At each step, the process retains a smaller chunk containing the target information from the page at each step, thereby converging to the target after certain number of steps. These filters are specific to the application, and can be designed by exploiting the internal structure of the document, and building general rules using regular expressions. For web pages, HTML tags may be exploited for the internal structure of the document. For natural language text, these filters may be designed by looking at part of speech tags, or sentence structures.

Advantageously, the described embodiments may be applied to an arbitrarily large number of web pages from any domain and with a minimum of user interaction. The fact that the algorithm decouples learning from the specific rule building enables the approach in handling web pages built using the latest technologies by defining appropriate filters. Further, embodiments as described can extract target information from any kind of partially structured text. The underlying documents need not be web pages. Some embodiments can extract target information from pages containing a mixture of languages (e.g. JavaScript, JSON, HTML, YAML etc.). The described approach can be highly extensible to a variety of new grammars/structures. This is possible because of the separation between the input-dependent filters (that depend on the kind of pages being processed) vs. the input-independent learning mechanics (how to concatenate these filters how to refine/generalize them, etc.). In addition, the described approach does not assume that the target information is contained by itself in an HTML tag.

These, and other, aspects will be better appreciated and understood when considered in conjunction with the following description and the accompanying drawings. The following description, while indicating various embodiments and numerous specific details thereof, is given by way of illustration and not of limitation. Many substitutions, modifications, additions or rearrangements may be made within the scope of this disclosure, which includes all such substitutions, modifications, additions or rearrangements.

### DESCRIPTION OF THE FIGURES

The drawings accompanying and forming part of this specification are included to depict certain aspects of various embodiments. A clearer impression of these embodiments, and of the components and operation of systems provided with them, will become more readily apparent by referring to the exemplary, and therefore nonlimiting, embodiments illustrated in the drawings, wherein identical reference numerals designate the same components. Note that the features illustrated in the drawings are not necessarily drawn to scale.

FIG. 1 depicts a logical diagram illustrating a data structure comprising rules and filters.

FIG. 2 illustrates exemplary rule application according to embodiments.

FIG. 3 depicts a block diagram of one embodiment of an architecture in which a wrapper induction system may be utilized.

FIG. 4 depicts a flowchart illustrating operation of an embodiment.

FIG. 5 depicts a flowchart illustrating operation of an embodiment.

FIG. 6 depicts a diagram illustrating exemplary rule states.

FIG. 7 depicts a diagram schematically illustrating an iteration process.

FIG. 8 depicts a diagram illustrating merging exemplary filters.

### DETAILED DESCRIPTION

Various features and advantageous the present disclosure are explained more fully with reference to the nonlimiting embodiments that are illustrated in the accompanying drawings and detailed in the following description. Descriptions of well-known starting materials, processing techniques, components and equipment are omitted so as not to unnecessarily obscure the present disclosure. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure. Embodiments discussed herein can be implemented in suitable computer-executable instructions that may reside on a computer readable medium (e.g., a hard disk (HD)), hardware circuitry or the like, or any combination.

Before discussing specific embodiments, a brief overview of the context of the disclosure may be helpful. Wrapper induction is the process of learning wrappers given a set of training documents as input. Here, the goal is to extract predefined target objects given a set of documents, such as web pages. An Input may be defined as {(text 1, target 1), (text 2, target 2), . . . , (text n, target n)}. The inputs, then are a given text (e.g., web page), typically a given sub-domain of a given domain, and a given target. An Output may be defined as F(subdomain, text) such that F( ) when applied to a previously unseen text from the same sub-domain, will return the text object (target) from that page. That is, the output is a domain-specific function (wrapper) that, when applied to pages in the (sub)domain, will return the given target.

It is noted that, in some embodiments, it is assumed that there is some “consistent” structure that identifies the location of the object of interest. Examples of such constant or consistent properties include: (a) Neighboring structure (e.g. what is before and/or after the target), (b) Enclosing structure (what encloses the target), and (c) Object Properties (what is the template representing the target).

The goal, then, is to identify the structure and encode/represent it as a template, e.g., HTML pages and price, address and phone number. Challenges in achieving this goal can include the following: (1) A page may contain multiple instances of strings that match the expression of interest. This means that a simple regular expression-based search is not sufficient; (2) Multiple templates (indistinguishable) may be used in a set of webpages from a domain. Each of these templates would need different rules to extract the target string; (3) How to represent various kinds of filters; (4) Possible variations of the target expressions in the document. For instance, (A) a target of 19.00 may occur as 19.000 in the text, (B) a target of AZ234 might appear as AZ-234, AZ-2-34 etc., (C) a target string of 123456789123 might appear as 0123456789123.

To address the problem of multiple strings matching the template or multiple occurrences of structure around the target, it may be necessary to identify a larger structure until the structure is considered unique. This can be achieved by following a filtering approach. According to embodiments, a “filter” forms the foundational step in the process. A filter may be generated using a variety of candidate filter generators. Within this disclosure, a “rule” is a conjunctive concatenation of filters, which when applied sequentially produces the target text output. Within this disclosure, a “rule set” is a disjunctive, collection of rules, specifically to add fail-safe set of rules that may handle multiple indistinguishable templates.

More particularly, as will be explained in greater detail below, within this disclosure, a “filter” is a program that reduces the input text into a smaller text by extracting some portion of it, or equivalently, deleting some portion of it. In this case, the filter defines building blocks that identify the portions of pages that are retained (or discarded). A “rule” is a composition of filters in a particular order. A rule applies the filters one after the other, and reduces the page to a smaller size. A “rule set” is a collection of rules that may be applied on a page. The rule set when applied to a page results in a number of outputs that is same as the number of rules present in the page.

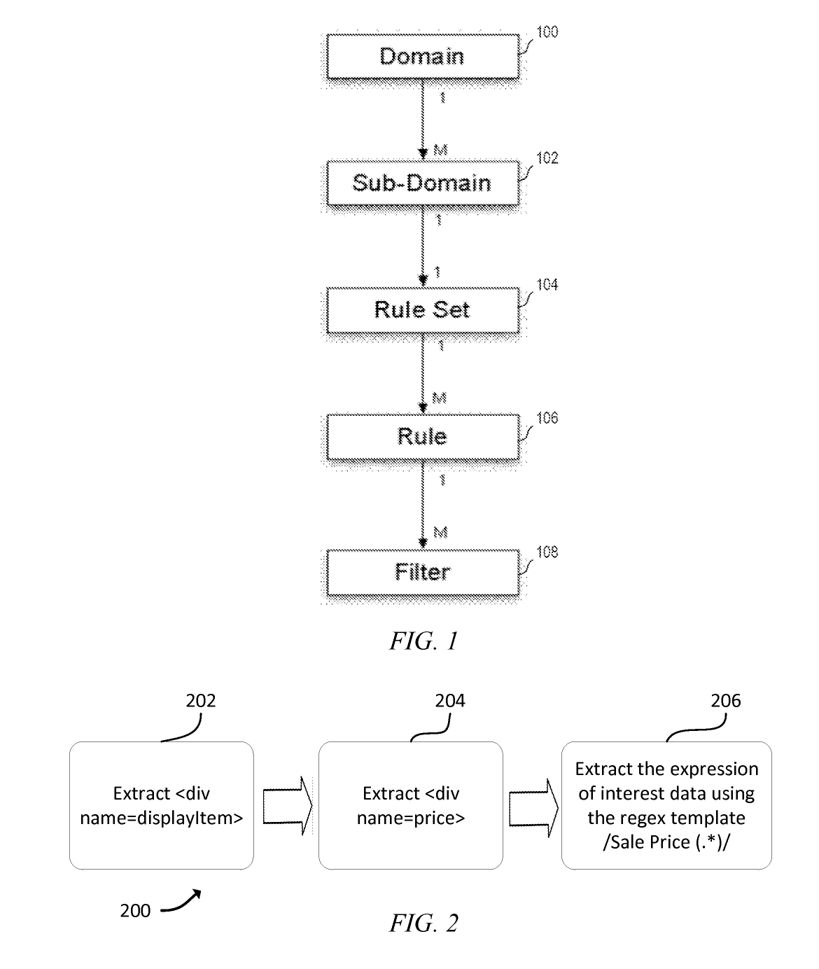

This is illustrated schematically in FIG. 1. Relationships are shown using 1-1 and 1-M, where 1-1 means one-to-one, and 1-M means one-to-many mappings. That is, each domain 100 has multiple sub-domains 102. Each sub-domain 102 has a single rule set 104. Each rule set 104 has multiple rules 106 both for redundancy and for accounting for multiple page templates in that sub-domain. Each rule 106 is a composition of multiple filters 108.

Application of an example rule 200 is shown in FIG. 2. More particularly, the rule 200 includes three filters 202, 204, 206. The rules are applied sequentially to extract a particular target (in this example, the sale price of a display item) from a document such as a web page. For example, as shown, filter 202 extracts the data corresponding to the div tag name—display item, while filter 204 extracts data corresponding to the div tag name=price. Filter 206 extracts data corresponding to a predetermined template (structure). As will be explained in greater detail below, the result of application of the rule may be one or more character strings or blocks which may be further processed.

Different types of filters are contemplated according to concepts described herin. For the case where HTML documents are being processed to extract say, price information, the filters can be divided into two types: those that rely on the structure of the document and those that rely on the content. Regular expression based rules, for example, rely on the text content of the document, whereas the HTML based rules like those that record Cascading Style Sheets (“CSS”) tags or HTML tags leading to the target expression are classified under structural rules. Parsing the document and recording the partial paths to the target expression helps in learning the structural filters. Appendix D, which accompanies and forms part of this disclosure, further describes learning regular expression filters. Content-based filters, on the other hand, are learned by recording a part of the text content around the target expression that is consistent and representable.

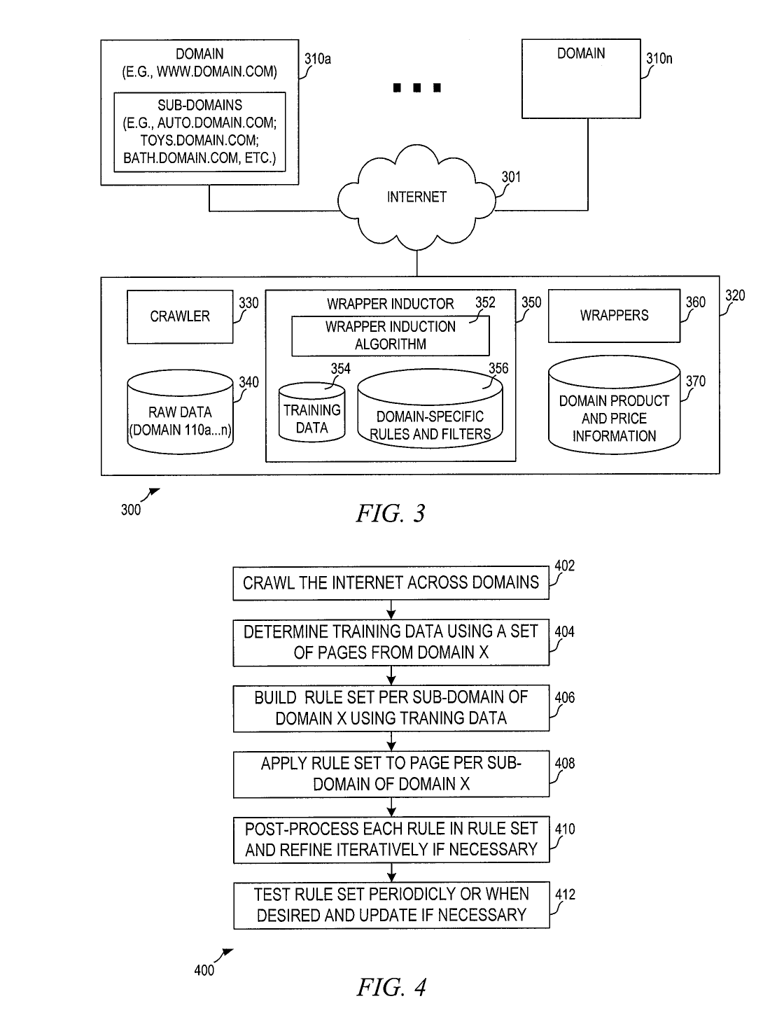

Turning now to FIG. 3, a block diagram illustrating an exemplary system 300 for implementing wrapper induction in accordance with embodiments is shown. The wrapper induction system 320 couples to a network such as the Internet 301 and has access to domains 310a . . . 310n. The domains may be of the form www.domain.com and may include a plurality of sub-domains of the form abc.domain.com or wxy.domain.com, etc.

The wrapper induction system 320 may include a wrapper inductor 350 implementing a wrapper induction algorithm 352 and storing training data 354 and domain-specific rules and filters 356, as will be explained in greater detail below.

The wrapper induction system 320 may further include or be in communication with a crawler 330 operable to crawl the Internet for specific domains and stores them in a raw data store 340. The training data 354 may include a predetermined number of web pages of a particular sub-domain from the raw data store 340. Generated wrappers may be stored at 360 and the desired target information, such as product and price information obtained from applying the wrappers, may be stored at 370.

Turning now to FIG. 4, a high level flowchart 400 illustrating operation of an embodiment is shown. As will be explained in greater detail below, a web crawler 330 of the system 320 may crawl the Internet 301 across unbounded domains for data and store them in raw data store 340 (step 402). In particular, in some embodiments, the raw data may comprise pages of sub-domains for a particular domain.

A predetermined set of training data 354 (such as a particular price for a particular product, etc.) are then defined using a set of pages (for example, 10 pages or less) from the targeted sub-domain (step 404).

A set of rules based on the sub-domain are then developed using the training data (step 406), as will be explained in greater detail below. The set of rules may be based on one or more filter candidates and using a filter generator implemented by the wrapper induction algorithm 352.

The set of sub-domain specific rules are then applied to the training data (in this example, a set of pages from the sub-domain) (step 408). More specifically, the filters in each rule in the rule set are applied in sequence to each page in the training set of pages from the sub-domain. The outputs obtained may be post-processed depending on a given rule state, refined iteratively if necessary until a suitable rule set is obtained for each sub-domain (step 410). Once finalized, each rule set may be tested periodically or when desired, and updated if necessary (step 412).

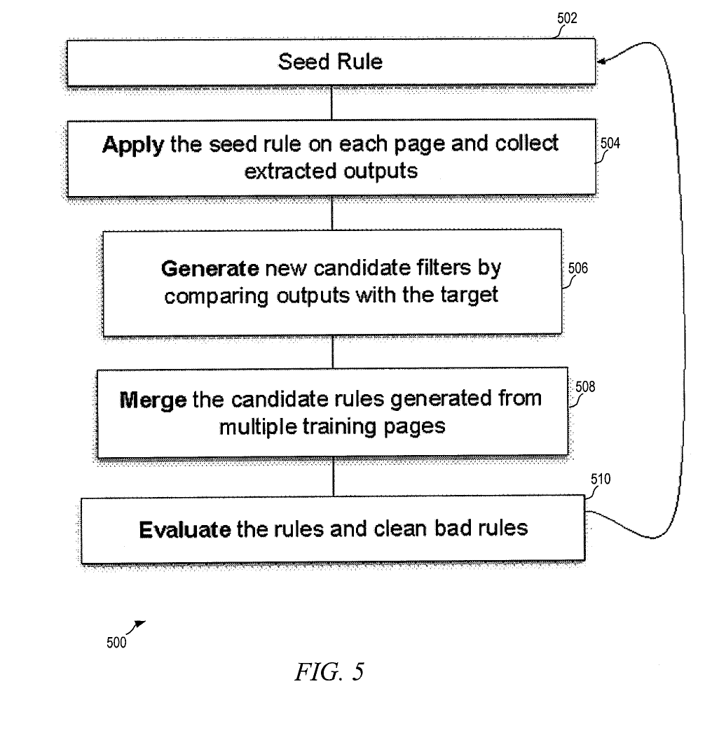

The iterative training process is illustrated more particularly with reference to the flowchart 500 of FIG. 5. Initially, a seed rule or rules are defined (step 502). These typically are “empty” logical constructs designed to start the process. In addition, a target (e.g., the price of a product) and one or more pages of the particular sub-domain are specified as a training set. The seed rules are applied to each page in the training set and associated outputs are collected (step 504). As will be explained in greater detail below, candidate filters are then generated by comparing the outputs with the desired target (step 506). That is, these outputs are fed into candidate filter generators that generate candidates that are appended to the corresponding seed rules.

The filters are applied to the outputs and the candidate rules generated from multiple training pages may be merged (step 508). These augmented merged rules may then be applied on the documents to verify their quality and are tagged using a rule status, and may be cleaned by deletion if they don't perform better than a manually specified threshold (step 510). These rules may then form the seed rules for the next iteration and the algorithm repeats from step 502.

As noted above, rule generation is an iterative process that requires application of rules to a training set. That is, in operation, rules are applied to particular pages in a sub-domain and a rule-learning algorithm iteratively refines the rule based on intermediate outputs. The intermediate outputs obtained from the rules are processed depending on rule states.

As will be explained in greater detail below, each rule when applied may result in multiple outputs from the document. For example, if a rule tries to pull the <div name=product> tag from a particular web page, there could be multiple such <div>s present in the page. If the page designer has only one tag that has a particular style associated with it, a single result may be produced after the application of the rule. Depending on whether the outputs exactly match the desired outputs, and the number of such outputs found, the rule at each stage can be in a set of multiple states.

That is, at a given stage, the output of the rule may be a single string or a set of multiple strings. Each output string may be precise or imprecise depending on the quality of the rule. When there are multiple output strings after application of a rule, the desired expression of interest could consistently occur in a given position in the output list, or it could vary. Depending on the output state, the iterative learning algorithm may need to continue on for another iteration or may deem the rule to be “good.”

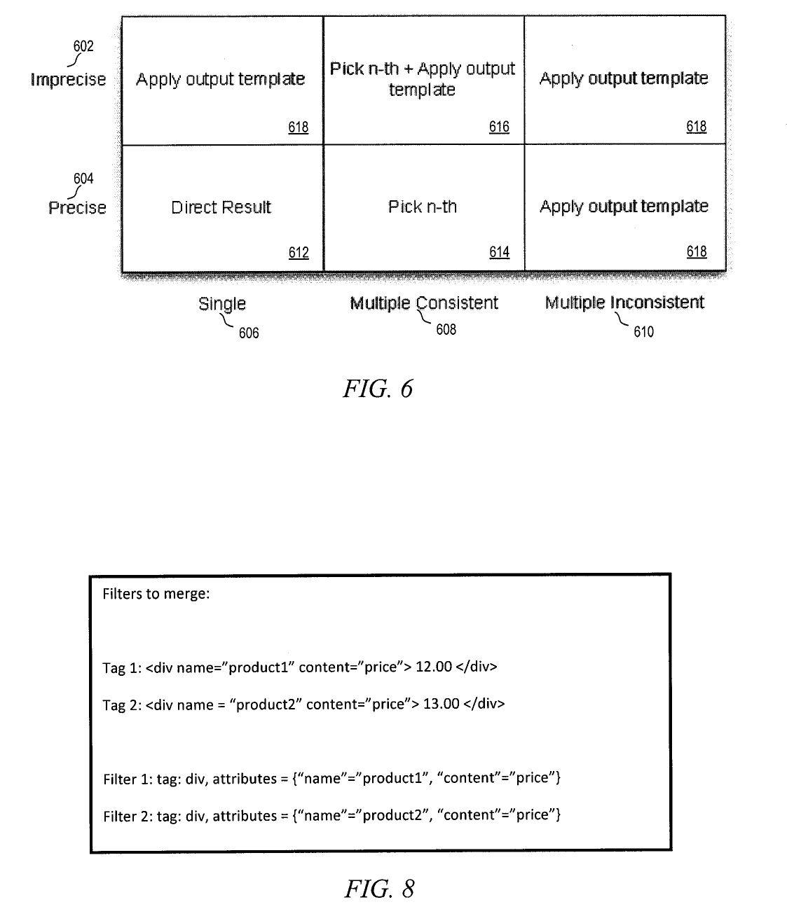

The possible states of a given output stage are shown in FIG. 6. At a given time during training, a rule may be in an imprecise state 602 or a precise state 604. In addition, for each of the precise and imprecise states, the rule may be in a single 606, multiple consistent 608, or multiple inconsistent states 610.

Over the course of wrapper learning, the goal is to move the rule toward the single-precise state. When the rule ends up in single-precise state 612, there is no need for any further preprocessing. That is, when a single output consistently results, the rule is deemed “good.” If the result is multiple consistent at an n-th stage of the algorithm 614, then the rule used at the nth stage is deemed “good” assuming that the rule will consistently generate the desired solution at position n. If the result at the nth stage is multiply consistent, but with multiple results (imprecise) 616, then the nth stage rule is used with a filter corresponding to the output template. In other words, when the rule is imprecise, and there is a “template” description of the desired output is present (e.g. UPC is 12 digits long, or price may potentially have a $ preceding it), one can apply a filter that can extract the part of the imprecise string that matches the template. In all other cases 618, the output template is applied.

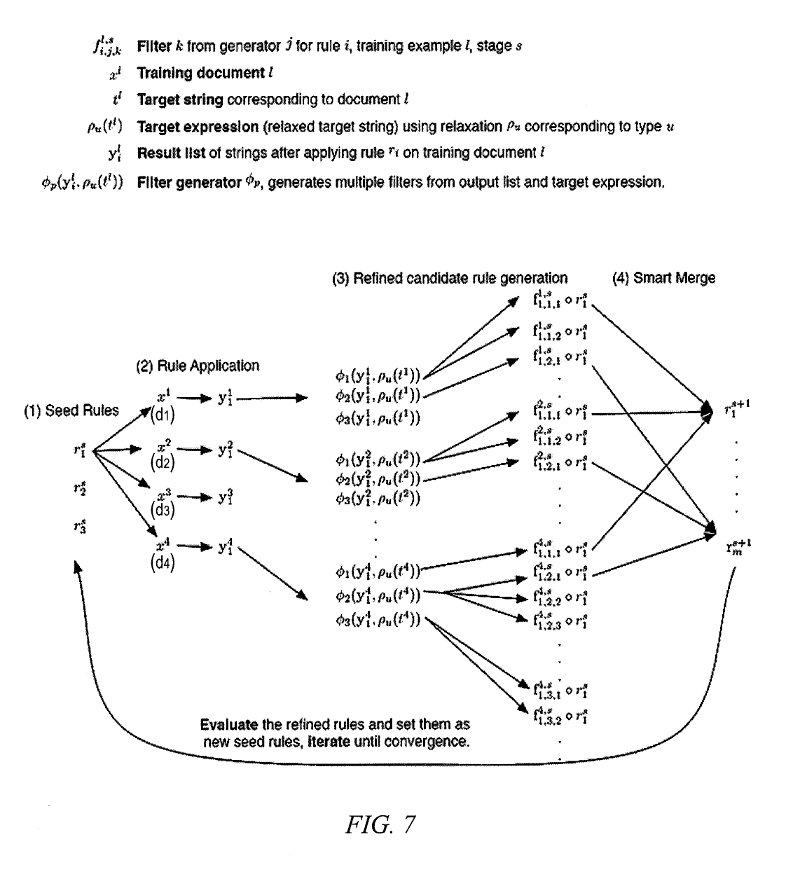

Iterative rule refinement and, particularly, the candidate rule generation and merging are shown schematically in FIG. 7. As shown, r denotes a rule, and r1,s denotes rule 1 at stage s. A general rule in stage s is represented as r_s. We start with an empty set of seed rules. These are applied on the text documents provided as input d_i. Each of the rules gives an output y_i for the training document d_i. Further, y_ji denotes the output of applying rule r_j over document d_i. The rules (except when they are empty) ensure that the resulting output on a document is smaller than the input document itself. That is, the rules filter the document by removing chunks corresponding to the filters defined in the rule. Assuming that the desired target text has not been identically returned, these pared down output chunks are then sent to the various candidate filter generators implemented as a part of the wrapper induction program. These candidate rule generators take in the input document and “learn” a rule from a predefined set of hypothesis classes.

For example, shown in Table 1 below, are exemplary filter types that may be used to generate a filter. It is noted that the list in nonlimiting; in any particular implementation, additional or even fewer types may be used.

TABLE 1

| | |
|---|---|
| HTML Tag | Marks the particular HTML tag to retain that contains |
| | the target |
| HTML Tag with | Records <div>, <span> tags containing the target with |
| CSS | their attributes |
| CSS Attribute | Records if the target is present in one of the attributes |
| | of a CSS based tag. |
| Table Row | Records the table and the row and column ID |
| Column | |
| JSON | Records the content of a tag, verifies it if is JSON and |
| | if yes, records the path to the target |
| Left word marker | Records the word to the left of the target (possibly |
| | separated by non-alphanumeric characters) |
| Two side word | Records words on both sides of the target (possibly |
| marker | separated by non-alphanumeric characters) |
| Fixed Buffer | Records fixed size buffers on both sides |
| marker | |
| Non-ASCII | A regular expression based filter that retains only |
| remover | ASCII part of a string. |
| JavaScript | Identifies and records JavaScript variables that may |
| variable marker | contain the target |

In operation, a filter learner takes a text document (either the web page itself or the output of a previous stage) and a search string (expression or target of interest), and builds a candidate filter using one of the filter types. For example, when processing HTML documents, a candidate rule may involve identifying the html tags such that extracting the tag will result in a document containing the search term.

For example, a user may manually examine a web page, such as retailer's web page, and identify the price of an item, e.g., $12.00. He defines “12.00” as the target search string, and the filter learner applies one or more of the defined filter types to the page with the defined target.

Many of the filter types will return nothing (indicating that items of that type are not present in the document), but suppose, for example, that the CSS attribute filter returns the string below, defining the CSS class ProdPrice. Assuming the resulting CSS filter picks out the same price from the remaining training pages, it is defined as a “good” (precise) rule:

```
    <html> <body> <table> <td> <div class=“ProdPrice”> 12.00
</div> </td> </table> </body> </html>
    target: 12.00.
```

If, however, the generated CSS filter produces no output or “junk” (i.e., text extracted using a filter that doesn't contain the target label string), then it is deemed imprecise and discarded.

Returning to FIG. 7, application of the candidate filter generation is shown at (3). In operation, the previously applied rule r1, for example, is appended with the newly generated filter(s) f and applied to the outputs yi_j. At this stage, if the rule or rules are returning consistent results, the process may go on to the next iteration, applying the newly devised rule back to the documents d_i.

In some embodiments, once updated rules have been identified, a “smart merge” may be applied. That is, while sometimes the rules may contain specific information from the page that may not apply to a different page, it may be possible to generalize a portion of the rules such that they may be applied to the other page. Smart merge identifies “similar” rules from different training pages and merges them in to a single rule that works on all these pages.

An example for smart merge in a specific case for extracting information from the HTML div tag, including merged rules and inputs, is given in FIG. 8. More particularly, shown in FIG. 8 are a Tag 1 and a Tag 2 and a Filter 1 and a Filter 2. The target text (12.00 and 13.00) is similar to within a predetermined degree or range. (In other embodiments, the user may define a range for the target text, either singly or in combination with a unique target, such as a UPC). In such a case, a user may want to define the text as “same” for the sake of the rules application. For example, a same product may have a slightly different price and he may not wish to exclude one at the expense of another. Accordingly, in some embodiments, Filter 1 and Filter 2 may be merged using predefined “wild cards.” For example, an exemplary merged filter M1 may use an asterisk wildcard for the “name” attribute, while an exemplary merged filter M2 may use the backslash wild card. In either case, variable values of the attribute may be defined in the filter.

Although the present disclosure has been described in terms of specific embodiments, these embodiments are merely illustrative, and not restrictive. The description herein of illustrated embodiments, including the description in the Abstract and Summary, is not intended to be exhaustive or to limit the disclosure to the precise forms disclosed herein (and in particular, the inclusion of any particular embodiment, feature or function within the Abstract or Summary is not intended to limit the scope of the disclosure to such embodiments, features or functions). Rather, the description is intended to describe illustrative embodiments, features and functions in order to provide a person of ordinary skill in the art context to understand the present disclosure without limiting same to any particularly described embodiment, feature or function, including any such embodiment feature or function described in the Abstract or Summary. While specific embodiments are described herein for illustrative purposes only, various equivalent modifications are possible, as those skilled in the relevant art will recognize and appreciate. As indicated, these modifications may be made in light of the foregoing description of illustrated embodiments and are to be included within the spirit and scope of the disclosure. Thus, various changes and substitutions are intended in the foregoing disclosures, and it will be appreciated that in some instances some features of embodiments will be employed without a corresponding use of other features without departing from the scope and spirit as set forth. Therefore, many modifications may be made to adapt a particular situation or material.

Reference throughout this specification to “one embodiment,” “an embodiment,” or “a specific embodiment” or similar terminology means that a particular feature, structure, or characteristic described in connection with the embodiment is included in at least one embodiment and may not necessarily be present in all embodiments. Thus, respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein.

In the description herein, numerous specific details are provided, such as examples of components and/or methods, to provide a thorough understanding of described embodiments. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments. A person of ordinary skill in the art will recognize that additional embodiments are readily understandable from the disclosure.

Embodiments discussed herein can be implemented in a computer communicatively coupled to a network (for example, the Internet), another computer, or in a standalone computer. As is known to those skilled in the art, a suitable computer can include a central processing unit (“CPU”), at least one read-only memory (“ROM”), at least one random access memory (“RAM”), at least one hard drive (“HD”), and one or more input/output (“I/O”) device(s). The I/O devices can include a keyboard, monitor, printer, electronic pointing device (for example, mouse, trackball, stylist, touch pad, etc.), or the like.

ROM, RAM, and HD are computer memories for storing computer-executable instructions executable by the CPU or capable of being complied or interpreted to be executable by the CPU. Suitable computer-executable instructions may reside on a computer readable medium (e.g., ROM, RAM, and/or HD), hardware circuitry or the like, or any combination thereof. Within this disclosure, the term “computer readable medium” or is not limited to ROM, RAM, and HD and can include any type of data storage medium that can be read by a processor. For example, a computer-readable medium may refer to a data cartridge, a data backup magnetic tape, a floppy diskette, a flash memory drive, an optical data storage drive, a CD-ROM, ROM, RAM, HD, or the like. The processes described herein may be implemented in suitable computer-executable instructions that may reside on a computer readable medium (for example, a disk, CD-ROM, a memory, etc.). Alternatively, the computer-executable instructions may be stored as software code components on a direct access storage device array, magnetic tape, floppy diskette, optical storage device, or other appropriate computer-readable medium or storage device.

Any suitable programming language can be used, individually or in conjunction with another programming language, to implement the routines, methods or programs of embodiments described herein, including C, C++, Java, JavaScript, HTML, or any other programming or scripting language, etc. Other software/hardware/network architectures may be used. For example, the functions of the disclosed embodiments may be implemented on one computer or shared/distributed among two or more computers in or across a network. Communications between computers implementing embodiments can be accomplished using any electronic, optical, radio frequency signals, or other suitable methods and tools of communication in compliance with known network protocols.

Different programming techniques can be employed such as procedural or object oriented. Any particular routine can execute on a single computer processing device or multiple computer processing devices, a single computer processor or multiple computer processors. Data may be stored in a single storage medium or distributed through multiple storage mediums, and may reside in a single database or multiple databases (or other data storage techniques). Although the steps, operations, or computations may be presented in a specific order, this order may be changed in different embodiments. In some embodiments, to the extent multiple steps are shown as sequential in this specification, some combination of such steps in alternative embodiments may be performed at the same time. The sequence of operations described herein can be interrupted, suspended, or otherwise controlled by another process, such as an operating system, kernel, etc. The routines can operate in an operating system environment or as stand-alone routines. Functions, routines, methods, steps and operations described herein can be performed in hardware, software, firmware or any combination thereof.

Embodiments described herein can be implemented in the form of control logic in software or hardware or a combination of both. The control logic may be stored in an information storage medium, such as a computer-readable medium, as a plurality of instructions adapted to direct an information processing device to perform a set of steps disclosed in the various embodiments. Based on the disclosure and teachings provided herein, a person of ordinary skill in the art will appreciate other ways and/or methods to implement the described embodiments.

It is also within the spirit and scope of the disclosure to implement in software programming or code an of the steps, operations, methods, routines or portions thereof described herein, where such software programming or code can be stored in a computer-readable medium and can be operated on by a processor to permit a computer to perform any of the steps, operations, methods, routines or portions thereof described herein. Various embodiments may be implemented by using software programming or code in one or more general purpose digital computers, by using application specific integrated circuits, programmable logic devices, field programmable gate arrays, optical, chemical, biological, quantum or nanoengineered systems, or components and mechanisms may be used. In general, the functions of various embodiments can be achieved by any means as is known in the art. For example, distributed, or networked systems, components and circuits can be used. In another example, communication or transfer (or otherwise moving from one place to another) of data may be wired, wireless, or by any other means.

A “computer-readable medium” may be any medium that can contain, store, communicate, propagate, or transport the program for use by or in connection with the instruction execution system, apparatus, system or device. The computer readable medium can be, by way of example only but not by limitation, an electronic, magnetic, optical, electromagnetic, infrared, or semiconductor system, apparatus, system, device, propagation medium, or computer memory. Such computer-readable medium shall generally be machine readable and include software programming or code that can be human readable (e.g., source code) or machine readable (e.g., object code). Examples of non-transitory computer-readable media can include random access memories, read-only memories, hard drives, data cartridges, magnetic tapes, floppy diskettes, flash memory drives, optical data storage devices, compact-disc read-only memories, and other appropriate computer memories and data storage devices. In an illustrative embodiment, some or all of the software components may reside on a single server computer or on any combination of separate server computers. As one skilled in the art can appreciate, a computer program product implementing an embodiment disclosed herein may comprise one or more non-transitory computer readable media storing computer instructions translatable by one or more processors in a computing environment.

A “processor” includes any, hardware system, mechanism or component that processes data, signals or other information. A processor can include a system with a general-purpose central processing unit, multiple processing units, dedicated circuitry for achieving functionality, or other systems. Processing need not be limited to a geographic location, or have temporal limitations. For example, a processor can perform its functions in “real-time,” “offline,” in a “batch mode,” etc. Portions of processing can be performed at different times and at different locations, by different (or the same) processing systems.

It will also be appreciated that one or more of the elements depicted in the drawings/figures can also be implemented in a more separated or integrated manner, or even removed or rendered as inoperable in certain cases, as is useful in accordance with a particular application. Additionally, any signal arrows in the drawings/figures should be considered only as exemplary, and not limiting, unless otherwise specifically noted.

As used herein, the terms “comprises,” “comprising,” “includes,” “including,” “has,” “having,” or any other variation thereof, are intended to cover a non-exclusive inclusion. For example, a process, product, article, or apparatus that comprises a list of elements is not necessarily limited only those elements but may include other elements not expressly listed or inherent to such process, process, article, or apparatus.

Furthermore, the term “or” as used herein is generally intended to mean “and/or” unless otherwise indicated. For example, a condition A or B is satisfied by any one of the following: A is true (or present) and B is false (or not present), A is false (or not present) and B is true (or present), and both A and B are true (or present). As used herein, including the claims that follow, a term preceded by “a” or “an” (and “the” when antecedent basis is “a” or “an”) includes both singular and plural of such term, unless clearly indicated within the claim otherwise (i.e., that the reference “a” or “an” clearly indicates only the singular or only the plural). Also, as used in the description herein and throughout the claims that follow, the meaning of “in” includes “in” and “on” unless the context clearly dictates otherwise.

1. A method for automatically extracting information from a plurality of domains, the method comprising:
generating a first rule based, at least in part, on a target string, the first rule comprising at least one filter;
identifying a domain of interest from the plurality of domains;
generating a training set from the target string and at least one document in the domain of interest;
applying the first rule to each document in the training set to obtain a first set of target results;
comparing the first set of target results to a desired set of target results; and
creating a second rule based on comparing the first set of target results to the desired set of target results.

2. The method of claim 1, further comprising:
applying the second rule to each document in the training set to obtain a second set of target results;
comparing the second set of target results to the desired set of target results; and
creating a third rule based on comparing the second set of target results to the desired set of target results.

3. The method of claim 1, further comprising:
categorizing the first rule as precise or imprecise based on comparing the first set of target results to the desired set of target results; and
adding at least one other filter to the first rule when the first rule is categorized as imprecise.

4. The method of claim 2, further comprising:
categorizing the second rule as precise or imprecise based on comparing the second set of target results to the desired set of target results; and
adding at least one other filter to the second rule when the second rule is categorized as imprecise.

5. The method of claim 1, wherein creating the second rule comprises:
adding at least one other filter to the first rule.

6. The method of claim 1, wherein creating the second rule comprises:
removing at least one filter comprising the first rule and adding at least one other filter.

7. The method of claim 2, wherein creating the third rule comprises:
adding at least one other filter to the second rule.

8. The method of claim 2, wherein creating the third rule comprises:
removing at least one filter comprising the second rule and adding at least one other filter.

9. The method of claim 1, wherein the first set of target results comprises:
raw HTML information

10. The method of claim 1, wherein the first set of target results comprises:
at least one of JavaScript code, Javascript Object Notation (“JSON,”), or YAML information.

11. The method of claim 1, wherein the first set of target results comprises:
partially structured information.

12. A system for automatically constructing wrappers across a plurality of domains, said system comprising:
a memory; and
a processor coupled to said memory, said processor configured to:
generate a first rule based, at least in part, on a target string, the first rule comprising at least one filter;
identify a domain of interest from the plurality of domains;
generate a training set from the target string and at least one document in the domain of interest;
apply the first rule to each document in the training set to obtain a first set of target results;
compare the first set of target results to a desired set of target results; and
create a second rule based on comparing the first set of target results to the desired set of target results.

13. The system of claim 12, wherein said processor is further configured to:
apply the second rule to each document in the training set to obtain a second set of target results;
compare the second set of target results to the desired set of target results; and
create a third rule based on comparing the second set of target results to the desired set of target results.

14. The system of claim 12, wherein said processor is further configured to:
categorize the first rule as precise or imprecise based on comparing the first set of target results to the desired set of target results; and
add at least one other filter to the first rule when the first rule is categorized as imprecise.

15. The system of claim 13, wherein said processor is further configured to:
categorize the second rule as precise or imprecise based on comparing the second set of target results to the desired set of target results; and
add at least one other filter to the second rule when the second rule is categorized as imprecise.

16. The system of claim 12, wherein said processor is further configured to:
add at least one other filter to the first rule.

17. The system of claim 12, wherein said processor is further configured to:
remove at least one filter comprising the first rule and adding at least one other filter.

18. The system of claim 13, wherein said processor is further configured to:
add at least one other filter to the second rule.

19. The system of claim 13, wherein said processor is further configured to:
remove at least one filter comprising the second rule and adding at least one other filter.

20. The system of claim 12, wherein the first set of target results comprises:
raw HTML information.

21. The system of claim 12, wherein the first set of target results comprises:
at least one of JavaScript code, Javascript Object Notation (“JSON,”), or YAML information.

22. The system of claim 12, wherein the first set of target results comprises:
partially structured information.
